(19) United States
(12) Patent Application Publication
(10) Pub. No.: US 2017/0003424 A1
(43) Pub. Date: Jan. 5, 2017

(54) WIDE-RANGE INFRA-RED-REFLECTION AND ULTRA-VIOLET-CUT TRANSPARENT FILTERS BASED ON MAGNETICALLY RESPONSIVE PHOTONIC CRYSTALS

(71) Applicant: THE REGENTS OF THE UNIVERSITY OF CALIFORNIA, Oakland, CA (US)

(72) Inventors: Masoud Rahman, Davis, CA (US); Pieter Stroeve, Davis, CA (US); Ruxandra Vidu, Citrus Heights, CA (US)

(73) Assignee: THE REGENTS OF THE UNIVERSITY OF CALIFORNIA, Oakland, CA (US)

(21) Appl. No.: 15/204,134

(22) Filed: Jul. 7, 2016

Related U.S. Application Data
(63) Continuation of application No. PCT/US2015/011230, filed on Jan. 13, 2015.
(60) Provisional application No. 61/926,725, filed on Jan. 13, 2014.

(51) Int. Cl. G02B 5/20; B32B 38/00; B32B 37/14; G02B 5/26; G02B 1/00

(52) U.S. Cl. CPC G02B 5/208; G02B 5/26; G02B 1/005; G02B 5/206; B32B 37/14; B32B 38/0004; B32B 2307/40; B32B 2310/0831; B32B 2307/208

(57) ABSTRACT

Infrared and ultraviolet reflecting films and methods for producing the films using metal oxide particles such as TiO₂ or ZnO fibers that have been decorated with magnetically responsive particles such as super paramagnetic iron oxide nanoparticles (SPIONs) and a curable matrix. The size, position and orientation of the magnetically responsive fibers can be controlled. The orientation of the fibers can be controlled with the application of a magnetic field and the oriented fibers can then be fixed into position by curing the polymer matrix. Multiple layers with selected configurations of fiber sizes and orientation can be formed into laminates. The range of infrared wavelengths and the range of irradiance angles can be widened with successive layers of increasingly angled fiber sections, fiber section spacing and section sizes.

### CROSS-REFERENCE TO RELATED APPLICATIONS

This application is a 35 U.S.C. §111(a) continuation of PCT international application number PCT/US2015/011230 filed on Jan. 13, 2015, incorporated herein by reference in its entirety, which claims priority to, and the benefit of, U.S. provisional patent application Ser. No. 61/926,725 filed on Jan. 13, 2014, incorporated herein by reference in its entirety. Priority is claimed to each of the foregoing applications.

The above-referenced PCT international application was published as PCT International Publication No. WO 2015/106277 on Jul. 16, 2015, which publication is incorporated herein by reference in its entirety.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### BACKGROUND

1. Technical Field

The present technology pertains generally to films and film laminates and methods of production, and more particularly to films that can be coated or installed onto windows to prevent the entrance of Infrared (IR) and ultraviolet (UV) rays into a building and to prevent the escape of internal heat from inside of the building to the outside.

2. Background

Windows are one of the major pathways for energy transfer between the interior and exterior of a building. In order to optimize and manage the consumption of energy for heating, cooling, and lighting, many different designs and strategies have been developed for windows such as double-pane glazing, electro-chromic glasses, and energy-saving curtains, blinds, and shades. Most of these approaches are based on two mechanisms, blocking heat transfer through conduction and convection, or blocking the passage of light.

Among the available technologies, double-pane or triple-pane windows are effective at decreasing the energy transfer based on conduction and convection but usually do not affect the infrared (IR) transparency. Curtains, shades and blinds decrease both visible as well as IR light at the same time and the decrease of the visible light for many cases is not desired. In addition to the decrease of visible light, the blinds absorb the IR radiation and warm up transferring the radiant energy to the interior of the building due to their increased temperature. Therefore, from the IR point of view the shades, curtains and blinds are not effective in hot seasons.

Another approach to reducing energy transfer across a window was the use of colored glass. Although colored glass reduces the amount of sunlight entering through the window, it absorbs more visible light than infrared radiation thereby elevating the temperature of the glass and convection. Electrochromic windows do not affect the entry of IR radiation and also require energy for the change of color which is not an energy efficient approach.

A further approach to managing energy transfers through windows is to treat or coat the window glass itself to provide low emissivity characteristics. Glass surfaces can be treated or coated with a thin metallic layer that reflects a range of wavelengths in the infrared (IR) spectrum while allowing light in the visual spectrum to be transmitted through the glass.

However, the metal layer must be sufficiently thick and dense to reflect an acceptable level of solar energy and the visible light transmission is often below 50% as a result. The metal layer coated on the glass may also be subject to corrosion or discoloration from exposure to the weather decreasing the efficiency and diminishing the visual appearance and uniformity of the windows. Furthermore, these colored or treated glasses do not impede ultraviolet (UV) radiation.

Although these approaches may have an impact on the energy consumption of a building, they are not optimized from the IR radiation or UV point of view. In hot seasons, an ideal window should be able to reflect back all of the IR radiation while being transparent to all the visible light. However, in the cold season, the window should let both IR and visible light to enter the building while blocking the IR radiation from the inside from escaping the building.

Accordingly, there is a need for a window treatment that can effectively reflect a wide range of infrared wavelengths and restrict ultraviolet light entry that is easy and inexpensive to produce. The present technology satisfies these needs and is an improvement in the art.

### BRIEF SUMMARY

The technology described herein provides laminates and methods for controlling and combining UV-blocking and IR-reflection in a single polymeric film or film laminate. The UV blocking is provided by the film architecture in which sized metal oxide (TiO₂ or ZnO) fibers are embedded inside a UV-curable polymeric film. The IR-reflection is based on the tunable photonic crystal properties of aligned, oriented, fibers inside each film layer.

By changing the number of layers, the intensity of reflected IR can be controlled. By having multiple layers, with each layer having a specific reflection range, a wide range of wavelengths can be reflected at the same time by the whole film. By having multiple layers, each layer with a reflection in a specific irradiance range, wide ranges of reflection versus irradiance can be obtained.

The IR and UV reflective films can be deposited or installed on windows to prevent IR and UV penetration inside of a building or vehicle. This decreases the energy consumption required for cooling the house and prevents UV discoloration damage to the carpets, furniture and appliances that are inside. These flexible filter films can be applied to already available windows or car glasses and there is no requirement for replacing the whole window. The polymeric nature of the films also increases the safety of the glass. The film further protects the glass from breaking which improves the safety. The polymeric film also improves sound proofing and prevents conductive heat transfer of the window.

The methods for production of the IR-reflecting and UV-cut filter films avoid the cost of high vacuum deposition techniques and the high degree of precision needed to control the thickness of those films. The methods can also be customized for roll-to-roll production, which increases its large-scale automation capacity making the films affordable for building and vehicle applications.

Generally, the methods produce a composite film that has one or more layers of a transparent matrix such as a polymer and oriented UV absorbing material such as TiO₂ and ZnO metal oxides. The arrangement of UV-absorbing materials inside a film can be designed as regular and repetitive rows which will reflect IR radiation. The UV-absorbing material can be prepared in different shapes and dimensions. However, the fiber geometry has the advantage of simplifying the IR reflection design as well as the material and film preparation. Fibers can be prepared by electro-spinning or deposition on a temporary fiber-shaped substrate, for example.

In order to adjust the alignment of UV-absorbing material inside the matrix, magnetic material such as superparamagnetic iron oxide nanoparticles (SPIONs) are attached to the UV-absorbing material. This process will make them magnetically responsive. For example, by applying an electromagnetic field, the TiO₂ fibers will be aligned inside a polymeric matrix. Curing the matrix will fix the location of the fibers inside film. This produces UV-absorbing and IR-reflecting polymer film layers. High vacuum deposition and other expensive manufacturing techniques are not needed.

According to one embodiment, the method for preparing an infrared and ultraviolet reflecting film includes: (a) synthesizing magnetically responsive material such as super paramagnetic iron oxide nanoparticles (SPIONs); (b) preparing UV-absorbing material such as metal oxide fibers; (c) depositing magnetically responsive material on UV-absorbing material; (d) segregating the size of magnetically responsive UV-absorbing material such as cryogenically chopping the fibers; (e) separating the magnetically responsive UV-absorbing materials according to size; and (f) dispersing the magnetically responsive UV-absorbing material inside a curable matrix (such as UV-set, or thermoset polymers).

In another embodiment, the magnetic particles are super paramagnetic iron oxide nanoparticle (SPION) particles, synthesized by the steps: (a) providing a first solution containing a reducing agent; (b) providing a second solution containing Fe₂⁺ and Fe₃⁺ ions; (c) adding the second solution drop-wise to the first solution to form a third solution, and simultaneously stirring the third solution until SPIONs form; and (d) providing tetramethylammonium hydroxide to the third solution to prevent SPION agglomeration.

Deposition of the magnetic particles onto the surface of the metal oxide fibers to make magnetically responsive metal oxide fibers is performed in one embodiment by: (a) depositing a layer of SPIONS onto the surface of the metal oxide fibers; (b) depositing a layer of negatively-charged poly-anionic polymer layers, for example poly-styrene sulfonate (PSS), onto positively-charged layer of SPIONS; and then (c) alternately adding layers of positively-charged SPIONS and negatively-charged poly-anionic polymer to increase the magnetization value of the magnetically responsive metal oxide fibers.

The decorated fibers can be sectioned on one embodiment by cryogenically chopping the magnetically responsive metal oxide fibers by: (a) adding the magnetically responsive fibers to liquid nitrogen, thereby making frozen fibers; (b) exposing the frozen fibers to an ultrasonic environment, thereby making chopped fibers; (c) performing dynamic light scattering to determine the size distribution of the fibers; and then (d) performing electron microscopy to determine fiber size and diameter of the fiber sections.

In one embodiment, the sectioned fibers are separated according to size by: (a) adding the chopped fibers to a viscous media (such as molten paraffin) to form a solution; (b) applying an external magnetic field to the solution; (c) waiting for solution to solidify; (d) cutting the solidified solution into layers; and then (e) melting the cut layer of the solution to separate out the fibers of the same size.

The magnetically responsive oxide fibers are dispersed inside a curable matrix in one embodiment by: (a) dispersing magnetically responsive metal oxide fibers of same size inside a UV-curable polymer; (b) applying external magnetic field and UV radiation to prepare thin film; (c) evaluating UV absorbance of the film by UV-Visible spectroscopy; and then (d) evaluating IR-reflection of the film by IR spectroscopy equipped with reflectance module.

According to one aspect of the technology, a method is provided for orienting structures decorated with magnetic particles and a directed magnetic field and then fixing the structures on a polymeric matrix.

According to another aspect of the technology, a method for preparing magnetically responsive UV (MRUV) light absorbing materials is provided by attaching a magnetically responsive material to an ultraviolet (UV) light absorbing material.

Another aspect of the technology is to provide magnetically responsive structures that are flexible, low thermal conductors, transparent, and able to be embedded by polymeric materials.

A further aspect of the technology is to provide flexible laminates that have layers with aligned structures and multiple arrays of aligned structures that are positioned relative to each other such that light passing through the arrays is filtered on a wide wavelength range.

Yet another aspect is to provide a laminate with layers including aligned magnetically responsive structures and multiple arrays of aligned structures positioned at certain angles of each other such that light passing through the arrays is filtered on a wide wavelength range.

Further aspects of the technology will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWINGS

The technology described herein will be more fully understood by reference to the following drawings which are for illustrative purposes only:

FIG. 1A is a schematic side sectional view of a thin film laminate of at least three layers of vertically oriented fiber chains and each layer reflecting a different range of wavelengths.

FIG. 1B is a graph of wavelength-reflectance of the layers of FIG. 1A.

FIG. 2A is a schematic side sectional view of a thin film laminate of at least three layers of angularly oriented fiber chains and each layer reflecting at a different irradiance angle.

FIG. 2B is a graph of irradiance angel-reflectance of the layers of FIG. 2A

FIG. 3 is a schematic side sectional view of a window with different films on the interior and exterior surfaces and the ideal seasonal transmission and reflection of radiation.

FIG. 4 is a flow diagram of a method of forming wide range infrared reflection and ultra-violet cut polymeric laminates according to one embodiment of the technology.

### DETAILED DESCRIPTION

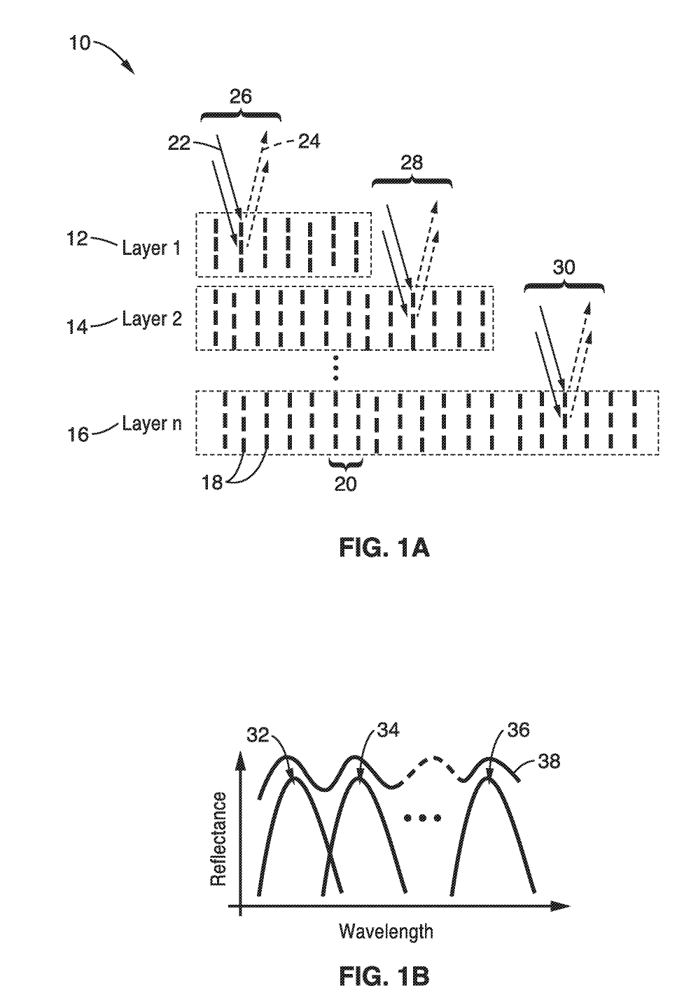

Referring more specifically to the drawings, for illustrative purposes, embodiments of the apparatus and methods for producing transparent glass or laminates with tunable wide range infrared reflection and ultra-violet cut capabilities using oriented layers of magnetically responsive photonic crystals of the technology described herein are described and depicted generally in FIG. 1A through FIG. 4. It will be appreciated that the methods may vary as to the specific steps and sequence and the apparatus may vary as to structural details without departing from the basic concepts as disclosed herein. The method steps are merely exemplary of the order that these steps may occur. The steps may occur in any order that is desired, such that it still performs the goals of the claimed technology.

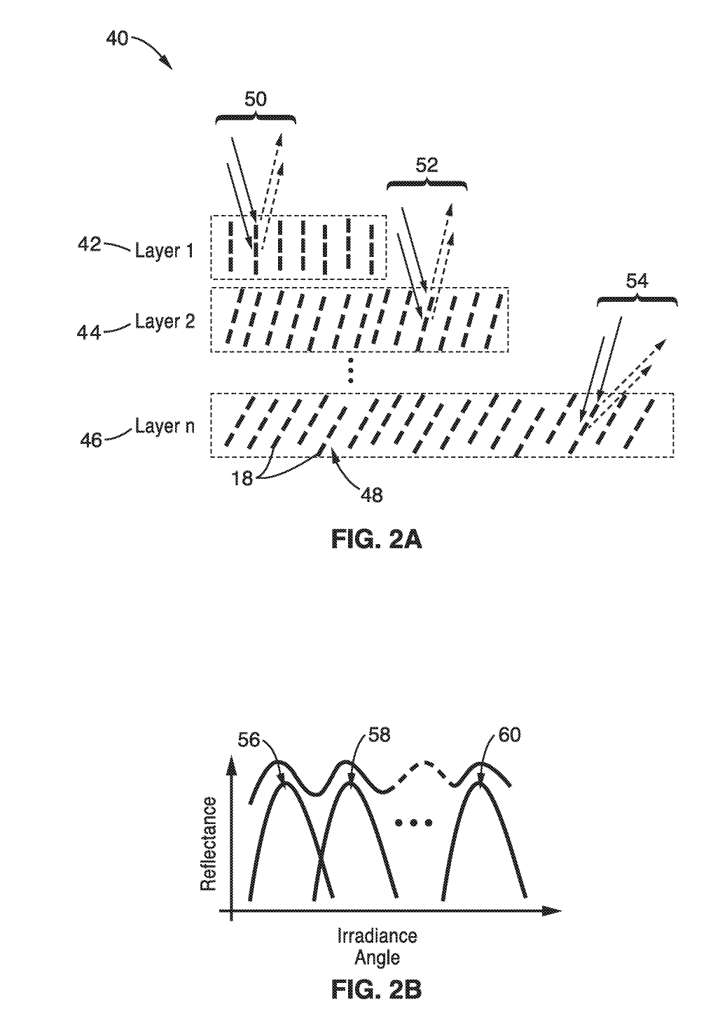

Turning now to FIG. 1A and FIG. 2A, the apparatus 10 generally provides polymeric films of at least one layer of an infrared (IR) and ultraviolet (UV) reflective material that can be deposited or installed on a window to prevent IR and UV penetration inside of a structure or vehicle. By way of example, and not of limitation, the film 10 illustrated in FIG. 1A is effectively a multi-layer wide IR range filter with each layer reflecting a specific range of IR wavelengths. By having multiple layers, each layer with a specific reflection range, a wide range of wavelengths can be reflected at the same time. By changing the number of layers, the intensity of reflected IR can also be controlled.

The structure 40 shown in FIG. 2A is effectively a multi-layer wide-angle reflectance filter where each layer reflects a specific range of irradiance angles. By having multiple layers, each layer with reflection in a specific irradiance range, as wide range of reflection versus the irradiance can be obtained.

It can be seen that the films can be formed from any number of layers and the layers 12, 14, 16 of FIG. 1A can be interposed with the layers 42, 44, 46 of FIG. 2A in forming a variety of structures that have different characteristics.

The film illustrated in FIG. 1A, has three layers 12, 14 and 16 and each layer produces a characteristic reflectance to certain wavelengths as shown in the inset graph. The layers include chains of vertically oriented fibers 18 with composition and spacing 20 that determines the reflectance ranges of the layer.

The fibers 18 are preferably made from TiO₂ or ZnO oxides. The fibers 18 are decorated with superparamagnetic iron oxide nanoparticles (SPION) that make the fibers magnetically responsive and allow them to be oriented by the application of a magnetic field during polymerization. Although SPION's are used in this illustration and are preferred, other magnetic particles can also be used to facilitate the orientation of fibers or chains of fibers.

The application of an external magnetic field during polymerization will result in the orientation of the decorated fibers in the film that is parallel to the magnetic field. The magnetically aligned fibers 18 inside a polymeric matrix can be used as a tool to prepare infra-red (IR) reflecting photonic crystals. The IR-reflection of one-dimensional (1-D) photonic crystals can be controlled by 1) the size of fibers, 2) the distances between the fibers inside the polymer, and 3) the angle between the incident IR beam and the direction of fibers. Therefore, the width of the IR spectrum that will be reflected can be broadened by stacking multiple layers. The incident light beam 22 is characteristically reflected back at an angle 26 as beam 24 and these ranges can be manipulated or tuned by the selection of fiber size and distance parameters.

Similarly, in the second layer 14 shown in FIG. 1A, a characteristic reflectance 28 for a wavelength range that is different than the reflectance 26 of the first layer 12 is provided. Subsequent layers 16 with other ranges of reflectance 30 can be added to increase the width of the IR spectrum that is reflected. This widening is illustrated in the graph of wavelength to reflectance shown in FIG. 1B. The reflectance 26 of the first layer 12 is shown as peak 32 and the reflectance 28 of the second layer and reflectance 30 of layer 16 are shown as peak 34 and 36 respectively. The overall range of wavelengths 38 reflected by the stack of layers is also shown in FIG. 1B illustrating the control over the range by the configuration of the layers of the final film.

The irradiance angle can also be tuned with the orientation of the chains of fibers 18 in each layer at selected angles 48 as illustrated in FIG. 2A. The angle 48 of the chains of fibers can be determined by the direction of an applied magnetic field during polymerization and can be variable and the chain angles can be sequentially larger or smaller with each layer. For example, the angle 50 of the fiber chains in layer 42 of FIG. 2A is essentially vertical. The irradiance angle 50 of the incident beam and reflected beam is comparatively small as seen by corresponding peak 56 in the graph of irradiance angle to reflectance shown in FIG. 2B.

The angle 48 of the fiber chains in the second layer 44 is greater than the vertical angle of the chains of the first layer as taken from the horizontal plane of the layer 44. The irradiance angle 52 of the second layer 44 is different and larger than the angle 50 of the first layer 42 as seen by the corresponding peak 58 in the graph of irradiance angle to reflectance shown in FIG. 2B. The irradiance angle 54 is increased in the third layer 46 with fiber chains with an angle 48 that is greater than the angle of fibers in the second layer 44 as seen by the corresponding peak 60 in the graph of irradiance angle to reflectance shown in FIG. 2B.

Accordingly, the breadth of irradiance angles covered by the whole film will increase by increasing the angle 48 of the fiber chains in the layers forming the film in this embodiment. The wavelengths and irradiance angles that are produced by the film can be narrow or broad or in several discreet ranges. Consequently, the lamination of multiple layers of IR-reflecting filters can be used to widen the range of IR-reflection wavelengths as well as having the reflection over a wider range of incident angles. Based on the selection of the UV-cut material and the concentration of the UV-cut fibers inside the polymeric films, UV wavelengths of about 400 nm to about 200 nm can be absorbed with an efficiency of 10% to 90%. Depending on the concentration of fibers and the number of films, wide IR wavelengths of 800 nm to 2000 nm can be reflected with 10% to 80% of the irradiated density.

These polymeric films can be easily attached to the windows of buildings and vehicles. Films with different filtering characteristics can be attached to one or more surfaces of single, double- or triple-paned glasses to control energy transfer between the interior and exterior of a building. The films can be attached to the exterior or interior surfaces of a single window pane as well as on enclosed surfaces of glass panes in double-paned or triple-paned windows.

A variety of alternative window designs are possible through the selection of the film characteristics, selection of the window type, and the selection of the surfaces of the panes that the films are applied. These design selections may also be influenced by general climate considerations such as whether the window installations or retrofitting will be in a predominantly hot climate near the equator or in a cold climate closer to the poles. Other designs can consider hot and cold seasonal variations.

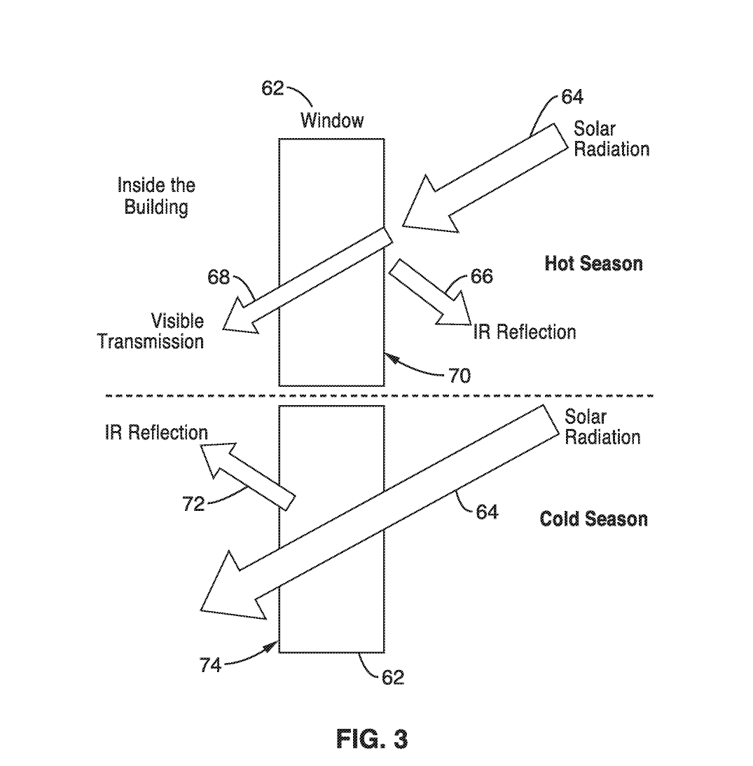

FIG. 3 illustrates one embodiment of an ideal single paned window 62 designed for use in hot and cold seasons. In the hot season (top), an ideal window 62 should be able to reflect back all the IR radiation 66 from incident solar radiation 64 while being transparent to all the visible light 68. Films attached to the outer surface 70 of the window 62 will reflect back the sun IR radiation 66 in the summer and therefore, without decreasing the transparency to visible light 68, the film will prevent the house from heating up.

However, in cold season (bottom), the window 62 should allow both IR and visible light to enter the building while blocking the IR radiation 72 from the inside from escaping to the outside of the building. For example, a filter film attached to the back side 74 of the window 62 prevents the IR radiation of the interior of the budding from being lost to the exterior during winter. This configuration can greatly decrease the energy consumption of the building during both hot and cold seasons.

Other configurations are also possible with double and triple pane windows that have four and six available surfaces for placement of different film configurations. Films can be selected based on the breadth of reflectance wavelengths as well as range of irradiance angles. Narrow or broad ranges of wavelengths and irradiance angles can be selected and film placement can be determined to give the window the desired overall characteristics.

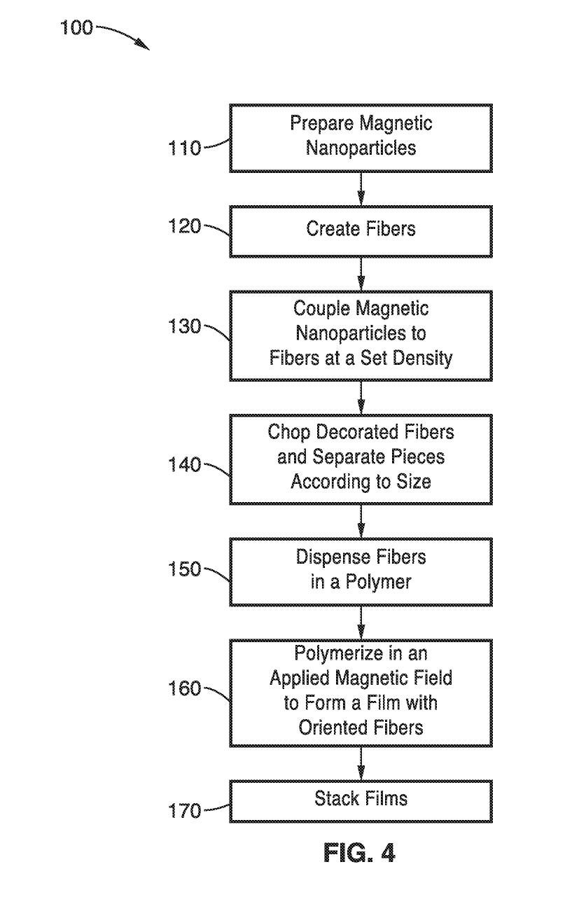

Turning now to FIG. 4, a flow diagram of one embodiment of a method 100 for producing polymeric films with tunable infrared reflection and ultraviolet light blocking characteristics is shown.

The steps of blocks 110, 120, 130 and 140 result in the production of magnetically-decorated-fibers (MFCs), which are magnetically responsive photonic crystals. Photonic crystals are high and low refractive index dielectric structures that are periodically repeated in a regular arrangement.

Initially, at block 110, magnetic nanoparticles are prepared. The magnetic nanoparticles that are prepared at block 110 are preferably superparamagnetic iron oxide nanoparticles (SPION). In one embodiment, the synthesis of SPIONs is preferably based on the co-precipitation of Fe₂⁺ and Fe₃⁺ ions in an aqueous solution. The nature of the synthesis of the SPIONs allows control over the size distribution, the super-paramagnetic properties, and the high saturation magnetization value. The preferred SPIONs have an average size of approximately 20 nm with a narrow size distribution and a saturation magnetization value of approximately 52.8 emu.g⁻¹.

One procedure for the synthesis of SPION begins with a starting solution of NH₄OH, (0.7 M), which acts as the reducer agent. A solution containing Fe₂⁺ and Fe₃⁺ ions may be prepared from FeCb.6H₂O (10.81 g in 40 ml of de-ionized water) and FeCh.4H₂O (3.97 g in 10 mL of HCl, 2M). The solution of iron ions is added drop-wise to the NH₄OH under a controlled atmosphere and continuous stirring to form the SPIONs. Optionally, particle agglomeration may be prevented by the addition of tetramethylammonium hydroxide (TMA).

Although superparamagnetic iron oxide nanoparticles are shown in this illustration, it will be understood that other materials and particle sizes can be used. In one embodiment, the magnetic material is micron-size crystals with superparamagnetic properties. In another embodiment, the magnetic particles that are produced at block 110 have a nonmagnetic core or shell of various shapes with magnetic material that can help align virtually any structures and make them magnetically responsive. In one embodiment the particle structure has a high aspect ratio. The particle structures can have a complex shape or can be solid or hollow. The magnetic material can be at the core or applied on to the exterior of the structure. The magnetic material can also be applied to the particle in multiple layers.

At block 120, metal oxide fibers are synthesized. Fibers made of TiO₂ or ZnO are particularly preferred. There are three main reasons for the selection of TiO₂ as a building block of the photonic crystals. First, TiO₂ has a high refractive index (around 2.5). A higher refractive index of TiO₂ compared to the polymer matrix is important for the formation of photonic crystals. Second, because TiO₂ is a powerful absorber of UV radiation, it has been widely used in sun-protection products. This property allows the production of filters which are UV-cut and IR-reflectors. Absorption of UV is important for the overall UV protection of the building since UV light can induce the degradation of carpets and equipment. Finally, the presence of TiO₂ inside the polymer can provide photocatalytic properties. However, for TiO₂ to be photo-catalytically active, it should be on a surface. The presence of the TiO₂ fibers inside the polymeric film also increases the film's toughness and scratch resistance at the same time which also makes the film easily washable.

Because the diameter, length, surface properties and TiO₂ content of the fibers can affect the subsequent processing steps, the TiO₂ fiber preparation can be challenging. In one embodiment, TiO₂/polymer fibers are produced by electrospinning. In an alternative embodiment, a deposition of TiO₂ layer on cellulose fibers can also be employed.

Electrospinning is a continuous nanofabrication technique based on the principle of electrohydrodynamics that is capable of producing nanowires or fibers of synthetic and natural polymers, ceramics, carbon, and semiconductor materials with a diameter in the range of between 1 nm to 2000 nm. The electrospinning method is based on extraction of a stream jet of a mixture of polymer/TiO₂ precursor inside a high electric field.

In one embodiment, a mixture of titanium (IV) propoxide and poly(vinyl acetate) (PVAc) in dimethyl formamide and an electric voltage of 15 kV is used in a conventional electrospinning setup. The electrospinning setup has a syringe which contains a mixture of the Ti precursor and some polymers. The syringe is connected to a pump for precise control of injection rate. Due to the high electric voltage between the syringe tip and the ground substrate, a stream of polymer-Ti precursor is extracted towards the ground substrate. The main parameters which determine the diameter and morphology of the TiO₂ fibers are: 1) syringe orifice diameter; 2) applied electrical voltage; 3) distance between syringe and the ground substrate; 4) chemical composition of the injection mixture; and 5) syringe pumping speed.

Another approach for the preparation of TiO₂ fibers is the deposition of TiO₂ on the surface of cellulose fibers by chemical bath deposition or layer-by-layer self-assembly techniques. In these cases the cellulose fiber acts as a substrate and determines the final diameter of the TiO₂ fibers. The cellulose can be removed by thermal decomposition which in will result in hollow TiO₂ fibers.

In order to make the TiO₂ fibers magnetically responsive, superparamagnetic iron oxide nanoparticles (SPION) are deposited homogeneously on the surface of the fibers at block 130. To have a uniform deposition on the fiber surface, a layer-by-layer self-assembly (LbL) method may be employed. The layer-by-layer self-assembly technique is preferred because is suitable for uniform deposition of geometrically complex surfaces such as fibers and offers a fine control over the deposition thickness of magnetic particles which permits better tuning of the magnetization properties of the fibers. LbL is also a solution based method and does not required sophisticated equipment, thus decreasing the production costs, and is compatible with roll-to-roll manufacturing processes.

This method is based on the alternative deposition of negatively-charged and positively-charged species on the surface of the fibers produced at block 120. By increasing the number of LbL cycles, the density of deposited SPIONs will increase on the surface of fibers which results in the increase of magnetization value of the fibers. Since the SPIONs may be capped with TMA to prevent their agglomeration in one embodiment, the particles will have a positive surface charge. TMA dissociates in aqueous solutions and forms [(CH₃)4Nt]⁺. The presence of this positive charge on the nitrogen atom of TMA is responsible for its positive charge.

Because LbL requires a negatively charged species to compensate for the positive charge of the SPIONs, polyanions can be used in this embodiment. By alternative deposition of negatively-charged polyanions and positively-charged SPIONs, the deposition can be continued and monitored with precise control over the deposition until the required amount of SPIONs is achieved. In one embodiment, poly styrene sulfonate (PSS) is used as the polyanion. The SO₃⁻ group on the backbone of the PSS is responsible for its negative charge.

When the required density of SPIONs on the fiber surface is reached, the LbL may be followed by the deposition of a polyelectrolyte layer such as the deposition of polyanion/polycation pairs in one embodiment. Polyethylene imine may be used as the polycation. Polyelectrolyte layers have two main functions: first, these polyelectrolyte layers entrap the SPIONs and prevent them from detaching from the fiber, and second, the surface properties of the fibers such as their solubility in different media, can be tailored by selecting and designing a proper polyelectrolyte layer.

At block 140 of FIG. 4, the fibers decorated with magnetic nanoparticles are sectioned into pieces that are separated according to size. In one embodiment, the magnetically decorated fibers are chopped by cryogenic ultra-sonication inside liquid nitrogen. This process is fast and simple. Liquid nitrogen is considered a cryogenic liquid with a temperature around 77 K. The addition of the fibers to liquid nitrogen causes the fibers to become completely brittle and fragile and the fibers will break instantly upon exposure to an ultrasonic environment. Because liquid nitrogen is not expensive, it can be used in large quantities. This process is also completely compatible with a scale-up process. The parameters which affect the average size as well as the size distribution of the fibers sections are the power of the ultra-sonication bath and the ultra-sonication time of exposured.

After the fibers are chopped, the sections may optionally be characterized to evaluate their properties. The size distribution of the fiber pieces can be determined by dynamic light scattering techniques. The magnetic properties of the fibers can be evaluated by a vibrating sample magnetometer (VSM). Scanning electron microscopy can also be employed for fiber size and diameter evaluations.

To separate fibers by size, the chopped fibers can be added to a high viscosity media. With the application of an external magnetic field, the fiber pieces will have a different speed in the viscous media depending on their size and the density of the SPIONs attached to the fiber pieces. In one embodiment, the chopped fibers are added to molten paraffin with the simultaneous application of an external magnetic field. The velocity of the fibers inside the high viscosity paraffin will be determined by their magnetization value and their size. After a period of time, a distribution of fibers of various sizes toward the magnet will be present. At this point, the paraffin can be solidified and cut into layers. Each layer will have fibers of the same size.

The fiber sections entrapped in each layer may be separated by melting the paraffin and several washing steps. For the washing step after melting the paraffin, the fibers may be collected on the bottom of the surface by application of an external magnetic field and the supernatant can be removed and replaced by toluene. In this step the molecular weight of the paraffin is a factor on its viscosity and melting point.

The decorated segmented fibers of similar sizes and magnetic characteristics produced at block 140 are dispersed in a polymer or polymers at block 150. In one embodiment, the fibers with the same size will be dispersed in a UV-curable polymer. A UV-curable polyethylene glycol) diacrylate polymer with a concentration of 5 wt % of fibers is particularly preferred. The key parameters which affect the properties of the cured film are the concentration of fibers, the surface functionalization of the fibers for better dispersibility inside the polymer, and the refractive index of polymer.

The sized fiber segments have the characteristics of photonic crystals. A photonic crystal is formed by an alternating arrangement of regular regions with high and low refractive indexes. The movement of light inside the photonic crystal is affected by these regular high and low refractive index zones. There is an optical band gap that does not let photons with a specific range of energies propagate inside the photonic crystal.

Photonic crystals can be classified as those which can be tuned externally (responsive to external stimulation) and those photonic crystals which after preparation cannot be changed. Among the externally tunable photonic crystals, magnetically responsive photonic crystals are colloidal based dispersions of magnetic nanoparticles which arrange into periodic structures due to the presence of an external magnetic field.

In this case, the distance between particles can be changed by changing the magnitude of the external magnetic field, which results in color changes. These are tunable, fast and reversible photonic crystals. The arrangement of particles with regular spacing results in the diffraction of light according to Bragg's formula.

The segmented decorated fibers from block 140 are photonic crystals that can be oriented in a polymer media by manipulation of the coated magnetic nanoparticles with a magnetic field. By applying an external magnetic field during the polymerization process at block 160, it is possible to arrange the magnetically decorated fibers in regular chains inside the polymer. The magnetization induced by an external magnetic field inside nanoparticles results in the interaction between nanoparticles through magnetic forces which is dependent on the angle between nanoparticles and finally results in the formation of chains of nanoparticles. The application of an external magnetic field during polymerization results in the orientation of the decorated fibers/fiber chains in the film parallel to the magnetic field. Controlling the fiber size and the distance between fibers also influences the characteristics of the film layer.

The fibers with a narrow size distribution are preferably mixed with a UV-curable polymer and cast as a thin layer while an external magnetic field is applied at block 160. All fibers will be fixed in an aligned configuration inside the polymer with the application of UV-radiation in this embodiment. Although a photo-curable polymer is preferred, other polymers and curing schemes can be used to fix the oriented fibers/fiber chains into position.

The orientation of fibers/fiber chains by manipulation of the applied magnetic field at block 160 allows the design of polymeric film layers with reflection in specific wavelength ranges. The reflection of electromagnetic wavelengths from the polymeric film can be tuned by the following parameters: 1) the length of the fibers; 2) the diameter of the fibers; 3) the distance between the fibers; 4) the refractive index of the polymeric matrix; and 5) the angle of the incident beam with the fibers.

Accordingly, each layer that is deposited and polymerized at block 160 can be tuned for reflectance of a specific range of wavelengths and orientated for a specific range of irradiance angles. However, the ranges of the final film can be expanded by stacking layers with a variety of configurations of fibers and orientations to form a laminate. By stacking the film layers one over the other at block 170, a wide range of IR-reflection will be possible as illustrated in FIG. 1A. In addition to the width of IR spectrum which can be reflected, by stacking multiple layers having reflection in a specific radiation angle, it is possible to increase the range of incident angles that can be reflected by the laminate as illustrated in FIG. 2A.

There is no limitation on the size or thickness of the thin films, which makes this process suitable for roll-to-roll production of polymeric IR-filters. This is a low-cost method for production of IR-reflecting and UV-cut filters, which makes them affordable for building and car applications.

From the discussion above it will be appreciated that the technology described herein can be embodied in various ways, including the following:

1. An infrared and ultraviolet reflecting film, comprising: a layer of UV light absorbing particles oriented in a transparent matrix to reflect a range of irradiance angles and a range of infrared wavelengths.

2. The film of any preceding embodiment, further comprising: a second layer of UV light absorbing particles oriented in a transparent matrix to reflect a range of irradiance angles and a range of infrared wavelengths that is different than the ranges of irradiance angles and infrared wavelengths of a first layer, the second layer disposed on the first layer.

3. The film of any preceding embodiment, further comprising: a plurality of additional layers of UV light absorbing particles oriented in a transparent matrix to reflect a range of irradiance angles and a range of infrared wavelengths, each layer having a ranges of irradiance angles and infrared wavelengths that are different from any other layer, each layer disposed on top of another to form a laminate of layers; wherein light passing through the layers is filtered on a wide range of wavelengths and a wide range of irradiance angles.

4. The film of any preceding embodiment, wherein the transparent matrix comprises a light curable matrix.

5. The film of any preceding embodiment, wherein the UV light absorbing material is a metal oxide fiber selected from a group of oxides consisting of: TiO₂ and ZnO.

6. The film of any preceding embodiment, wherein the particles of UV light absorbing material in any one layer has a size that is different than the size of particles of UV light absorbing material of any other layer.

7. A method for preparing an infrared and ultraviolet reflecting film, the method comprising: preparing particles of a magnetically responsive UV light absorbing material; mixing the magnetically responsive UV light absorbing material with one or more polymers; orienting the position of the magnetically responsive UV light absorbing particles with a magnetic field; and polymerizing the polymer to set the oriented positions of the magnetically responsive UV light absorbing particles.

8. The method of any preceding embodiment, further comprising: polymerizing a base layer of oriented magnetically responsive UV light absorbing particles; applying one or more top layers of magnetically responsive UV light absorbing material with one or more polymers to the base layer; orienting the position of the magnetically responsive UV light absorbing particles in each top layer with a magnetic field; and polymerizing the polymer of each top layer to set the oriented positions of the magnetically responsive UV light absorbing particles.

9. The method of any preceding embodiment, further comprising: controlling the size of the particles of magnetically responsive UV light absorbing material in each layer; controlling distances between particles; and controlling the orientation of the particles of magnetically responsive UV light absorbing material in each layer.

10. The method of any preceding embodiment, wherein the magnetically responsive UV light absorbing material is prepared by: providing an ultraviolet (UV) light absorbing material; providing a magnetically responsive material; and attaching the magnetically responsive material onto the UV light absorbing material to form a magnetically responsive UV light absorbing material.

11. The method of any preceding embodiment, wherein the magnetically responsive material comprises super paramagnetic iron oxide nanoparticles (SPION).

12. The method of any preceding embodiment, wherein the super paramagnetic iron oxide nanoparticles (SPION) are produced by: providing a first solution containing a reducing agent; providing a second solution containing Fe2⁺ and Fe3⁺ ions; and adding the second solution drop-wise to the first solution to form a third solution, and simultaneously stirring the third solution until SPIONs are formed.

13. The method of any preceding embodiment, further comprising: providing tetramethylammonium hydroxide to the third solution to prevent SPION agglomeration.

14. The method of any preceding embodiment, wherein the UV light absorbing material comprises metal oxide fibers formed by: providing a solution containing a metal oxide precursor, polyvinyl acetate and dimethyl-formamide; and electrospinning using the solution.

15. The method of any preceding embodiment, wherein the UV light absorbing material comprises metal oxide fibers formed by: depositing layers of metal oxide onto cellulose fibers by layer-by-layer self-assembly.

16. The method of any preceding embodiment, wherein the particles of a magnetically responsive UV light absorbing material are prepared by: providing SPIONS and metal oxide fibers; depositing a layer of SPIONS onto the surface of the metal oxide fibers; depositing a layer of negatively-charged poly-anionic polymer layers onto the positively-charged layer of SPIONS; and adding alternate layers of positively-charged SPIONS and negatively-charged poly-anionic polymer to increase the magnetization value of the magnetically responsive metal oxide fibers.

17. The method of any preceding embodiment, further comprising: cyrogenically chopping the magnetically responsive metal oxide fibers to size by: adding the magnetically responsive fibers to liquid nitrogen, thereby making frozen fibers; and exposing the frozen fibers to an ultrasonic environment, thereby making chopped fibers; and separating the chopped magnetically responsive metal oxide fibers according to size

18. The method of any preceding embodiment, wherein the separation of magnetically responsive metal oxide fibers according to size, comprises: adding chopped fibers to a viscous media to form a solution; applying an external magnetic field to the solution; solidifying the solution; cutting the solidified fourth solution into layers; and melting the cut layer of the fourth solution to separate out the fibers.

19. A method for preparing a laminate with oriented active particles, the method comprising: synthesizing particles of a magnetically responsive material; preparing fibers of an active material; depositing magnetically responsive material on the fibers of active material; sectioning the magnetically responsive active fibers and separating the sections according to size; dispersing the magnetically responsive active fiber sections inside a curable matrix; positioning magnetically responsive fiber sections with a magnetic field in the curable matrix; curing the positioned fiber sections in the matrix to form a base layer; applying one or more layers of additional active fiber sections in a curable matrix over the base layer; and curing each layer to form a laminate of multiple layers.

20. The method of any preceding embodiment, further comprising: controlling the size of the sections of magnetically responsive fibers in each layer; controlling distances between magnetically responsive fiber sections; and controlling the orientation of the sections of magnetically responsive fibers in each layer.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An infrared and ultraviolet reflecting film, comprising:
a layer of UV light absorbing particles oriented in a transparent matrix to reflect a range of irradiance angles and a range of infrared wavelengths.

2. The film as recited in claim 1, further comprising:
a second layer of UV light absorbing particles oriented in a transparent matrix to reflect a range of irradiance angles and a range of infrared wavelengths that is different than the ranges of irradiance angles and infrared wavelengths of a first layer, the second layer disposed on the first layer.

3. The film as recited in claim 2, further comprising:
a plurality of additional layers of UV light absorbing particles oriented in a transparent matrix to reflect a range of irradiance angles and a range of infrared wavelengths, each layer having a ranges of irradiance angles and infrared wavelengths that are different from any other layer, each layer disposed on top of another to form a laminate of layers;
wherein light passing through the layers is filtered on a wide range of wavelengths and a wide range of irradiance angles.

4. The film as recited in claim 1, wherein said transparent matrix comprises a light curable matrix.

5. The film as recited in claim 1, wherein the UV light absorbing material is a metal oxide fiber selected from a group of oxides consisting of: TiO₂ and ZnO.

6. The film as recited in claim 3, wherein the particles of UV light absorbing material in any one layer has a size that is different than the size of particles of UV light absorbing material of any other layer.

7. A method for preparing an infrared and ultraviolet reflecting film, the method comprising:
preparing particles of a magnetically responsive UV light absorbing material;
mixing the magnetically responsive UV light absorbing material with one or more polymers;
orienting the position of the magnetically responsive UV light absorbing particles with a magnetic field; and
polymerizing the polymer to set the oriented positions of the magnetically responsive UV light absorbing particles.

8. The method as recited in claim 7, further comprising:
polymerizing a base layer of oriented magnetically responsive UV light absorbing particles;
applying one or more top layers of magnetically responsive UV light absorbing material with one or more polymers to the base layer;
orienting the position of the magnetically responsive UV light absorbing particles in each top layer with a magnetic field; and
polymerizing the polymer of each top layer to set the oriented positions of the magnetically responsive UV light absorbing particles.

9. The method as recited in claim 7, further comprising:
controlling the size of the particles of magnetically responsive UV light absorbing material in each layer;
controlling distances between particles; and
controlling the orientation of the particles of magnetically responsive UV light absorbing material in each layer.

10. The method as recited in claim 7, wherein said magnetically responsive UV light absorbing material is prepared by:
providing an ultraviolet (UV) light absorbing material;
providing a magnetically responsive material; and
attaching the magnetically responsive material onto the UV light absorbing material to form a magnetically responsive UV light absorbing material.

11. The method as recited in claim 10, wherein the magnetically responsive material comprises super paramagnetic iron oxide nanoparticles (SPION).

12. The method as recited in claim 10, wherein the super paramagnetic iron oxide nanoparticle (SPION) are produced by:
providing a first solution containing a reducing agent;
providing a second solution containing Fe2⁺ and Fe3⁺ ions; and
adding the second solution drop-wise to the first solution to form a third solution, and simultaneously stirring the third solution until SPIONs are formed.

13. The method as recited in claim 12, further comprising:
providing tetramethylammonium hydroxide to the third solution to prevent SPION agglomeration.

14. The method as recited in claim 7, wherein said UV light absorbing material comprises metal oxide fibers formed by:
providing a solution containing a metal oxide precursor, polyvinyl acetate and dimethyl-formamide; and
electrospinning using the solution.

15. The method as recited in claim 7, wherein said UV light absorbing material comprises metal oxide fibers formed by:
depositing layers of metal oxide onto cellulose fibers by layer-by-layer self-assembly.

16. The method as recited in claim 7, wherein said particles of a magnetically responsive UV light absorbing material are prepared by:
providing SPIONS and metal oxide fibers;
depositing a layer of SPIONS onto the surface of the metal oxide fibers;
depositing a layer of negatively-charged poly-anionic polymer layers onto the positively-charged layer of SPIONS; and
adding alternate layers of positively-charged SPIONS and negatively-charged poly-anionic polymer to increase the magnetization value of the magnetically responsive metal oxide fibers.

17. The method as recited in 16, further comprising:
cyrogenically chopping the magnetically responsive metal oxide fibers to size by:
adding the magnetically responsive fibers to liquid nitrogen, thereby making frozen fibers;
exposing the frozen fibers to an ultrasonic environment, thereby making chopped fibers; and
separating the chopped magnetically responsive metal oxide fibers according to size.

18. The method as recited in claim 17, wherein said separation of magnetically responsive metal oxide fibers according to size, comprises:
adding chopped fibers to a viscous media to form a solution;
applying an external magnetic field to the solution;
solidifying the solution;
cutting the solidified fourth solution into layers; and
melting the cut layer of the fourth solution to separate out the fibers.

19. A method for preparing a laminate with oriented active particles, the method comprising:
synthesizing particles of a magnetically responsive material;
preparing fibers of an active material;
depositing magnetically responsive material on the fibers of active material;
sectioning the magnetically responsive active fibers and separating the sections according to size;
dispersing the magnetically responsive active fiber sections inside a curable matrix;
positioning magnetically responsive fiber sections with a magnetic field in the curable matrix;
curing the positioned fiber sections in the matrix to form a base layer;
applying one or more layers of additional active fiber sections in a curable matrix over the base layer; and
curing each layer to form a laminate of multiple layers.

20. The method as recited in claim 19, further comprising:
controlling the size of the sections of magnetically responsive fibers in each layer;
controlling distances between magnetically responsive fiber sections; and
controlling the orientation of the sections of magnetically responsive fibers in each layer.
